(19) United States
(12) Patent Application Publication
(10) Pub. No.: US 2007/0260586 A1
(43) Pub. Date: Nov. 8, 2007

(54) Systems and methods for selecting and organizing information using temporal clustering

(76) Inventors: Antonio Savona, Sora (FR) (IT); Antonino Gulli, Pisa (PISA) (IT); Luca Foschini, Barbiano (RA) (IT)

Correspondence Address: Stephen M. De Klerk;BLAKELY, SOKOLOFF, TAYLOR & ZAFMAN LLP, Seventh Floor, 12400 Wilshire Boulevard, Los Angeles, CA, 90025, US

(21) Appl. No.: 11/417,405

(22) Filed: May 3, 2006

(51) Int. Cl. G06F 17/30

(52) U.S. Cl. 707/3

(57) ABSTRACT

Systems and methods for organizing related news information is disclosed herein. The systems and methods include clustering a stream of news information according to the topic of each news information and according to temporal information of the news information. Systems and methods for presenting information to users are also disclosed herein. The systems and methods include receiving a search for news information from a user and presenting the news information according to the topic of the news information and the temporal information.

### FIELD

This invention relates to the field of search engines and, in particular, to systems and methods for searching and browsing information using temporal clustering.

### BACKGROUND

The Internet is a global network of computer systems and websites. These computer systems include a variety of documents, files, databases, and the like, which include information covering a variety of topics. It can be difficult for users of the Internet to locate information on the Internet. Search engines are often used by people to locate information on the Internet. Search engines are also sometimes used to locate news information.

Currently, when users browse for news information, the user is presented with several news categories, such as, for example, top stories, U.S., world, business, health, technology, entertainment and the like. When a user selects a news category, several selectable news articles related to the selected news category are then presented to the user. Similarly, when a user enters a search query for a particular news story, the user is typically presented with several selectable news articles related to the search query. Sometimes, a selected news article may include a link to other related news articles.

However, most search engines and news sites currently determine that articles are related with an exact title match. In addition, most search engines and news sites currently do not use the temporal information of the news article in organizing the news information or allow users of the sites to search or browse news information according to the temporal information.

### SUMMARY

A method for presenting information is described herein. The method includes receiving a request from a user to search news information for a topic; presenting the user with news information for the topic in accordance with the request, the news information presented in a hierarchy corresponding to temporal information of the news information.

The temporal information may be selected from the group consisting of publication time, clustering time, posting time, crawling time and combinations thereof.

Receiving a request may include receiving a search query for the topic. Receiving a request may include receiving a selection from a browsable list of topics.

The temporal information may be an incremental time period and the hierarchy may include a plurality of selectable links corresponding to the incremental time period.

The method may also include receiving a selection of a selectable link corresponding to the incremental time period and presenting the news information corresponding to the incremental time period.

The method may also include presenting a graphical illustration of the temporal information corresponding to the requested topic.

A method for organizing related news information is also described herein. The method includes clustering a stream of news information according to temporal information of the stream of news information to form a plurality of temporal clusters; and clustering each of the plurality of temporal clusters according to a topic of each news information to form a plurality of topic clusters.

The method may also include linking each of the plurality of topic clusters with topic clusters having the same topic according to the temporal information.

The stream of news information may be clustered periodically to form a plurality of periodic topic clusters. The method may further include linking each of the plurality of periodic topic clusters with each of the plurality of periodic topic clusters having the same topic according to the temporal information to form topic chains.

The temporal information may include the publication date of the stream of information.

A search system is also disclosed herein. The search system includes a crawler to periodically search for news information; an index, connected to the crawler, to store located information; and a server, connected to the index, to cluster the news information according to temporal information and a topic of the news information.

The server may be further to cluster the news information periodically.

The server may be further to link clustered news information according to the topic and the temporal information of the news information to form topic chains.

The index may be further to store the clustered news information. The system may further include a database to store the clustered news information.

The system may further include an interface for receiving user requests for the clustered news information. The interface may provide a response to the user request, the response being news information corresponding to the user request. The interface may allow a user to navigate the response according to the temporal information.

The temporal information may be selected from the group consisting of publication time, clustering time, posting time, crawling time and combinations thereof.

The server may be further to generate a graphical representation of the information.

### BRIEF DESCRIPTION OF THE DRAWINGS

The invention is described by way of example with reference to the accompanying drawings, wherein:

FIG. 1 is a block diagram illustrating a system for searching in accordance with one embodiment of the invention;

FIG. 2 is a flow diagram illustrating a method for organizing news information according to temporal information in accordance with one embodiment of the invention;

FIG. 2A is a block diagram illustrating organization of news information in accordance with one embodiment of the invention;

FIG. 2B is a block diagram illustrating organization of news information in accordance with one embodiment of the invention;

FIG. 3 is a schematic view of a user interface for locating news information in accordance with one embodiment of the invention;

FIGS. 4A-4H are schematic views of a user interface for locating news information in accordance with one embodiment of the invention;

FIGS. 5A-5B are schematic views of a user interface for locating news information in accordance with one embodiment of the invention; and

FIG. 6 is a schematic view of a user interface for presenting news information in accordance with one embodiment of the invention.

### DETAILED DESCRIPTION

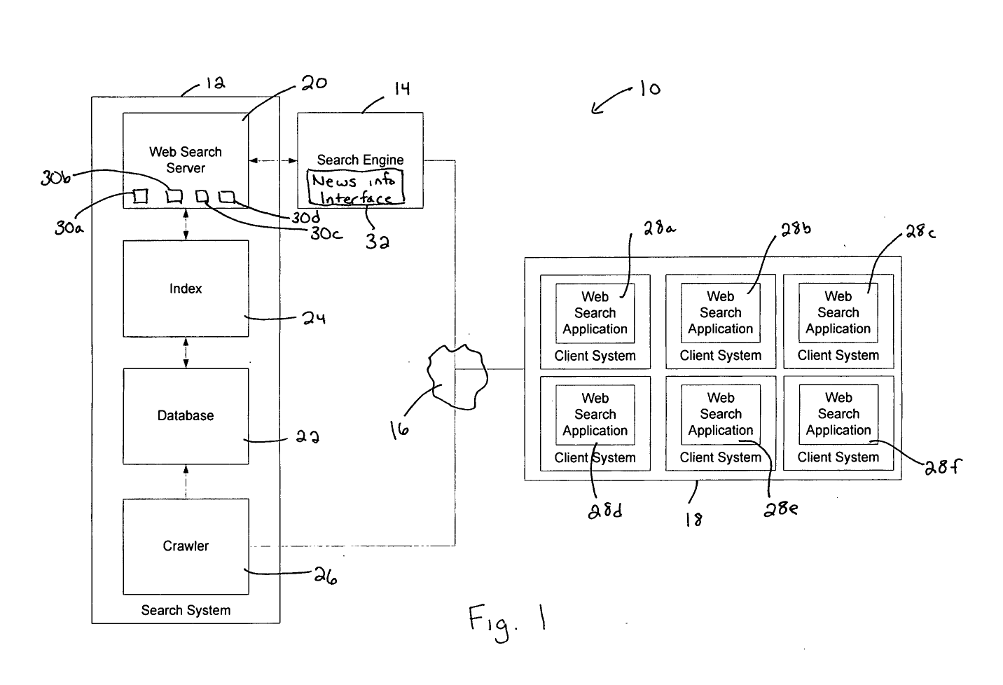

FIG. 1, of the accompanying drawings, shows a network system 10 which can be used in accordance with one embodiment of the present invention. The network system 10 includes a search system 12, a search engine 14, a network 16, and a plurality of client systems 18. The search system 12 includes a server 20, a database 22, an indexer 24, and a crawler 26. The plurality of client systems 18 includes a plurality of web search applications 28a-f, located on each of the plurality of client systems 18. The server 20 includes a plurality of databases 30a-d. The search engine 14 may include a news information interface 32.

The server 12 is connected to the search engine 14. The search engine 14 is connected to the plurality of client systems 18 via the network 16. The server 20 is in communication with the database 22 which is in communication with the indexer 24. The indexer 24 is in communication with the crawler 26. The crawler 26 is capable of communicating with the plurality of client systems 18 via the network 16 as well.

The web search server 20 is typically a computer system, and may be an HTTP server. It is envisioned that the search engine 14 may be located at the web search server 20. The web search server 20 typically includes at least processing logic and memory.

The indexer 24 is typically a software program which is used to create an index, which is then stored in storage media. The index is typically a table of alphanumeric terms with a corresponding list of the related documents or the location of the related documents (e.g., a pointer). An exemplary pointer is a Uniform Resource Locator (URL). The indexer 24 may build a hash table, in which a numerical value is attached to each of the terms. The database 22 is stored in a storage media, which typically includes the documents which are indexed by the indexer 24. The index may be included in the same storage media as the database 22 or in a different storage media. The storage media may be volatile or non-volatile memory that includes, for example, read only memory (ROM), random access memory (RAM), magnetic disk storage media, optical storage media, flash memory devices and zip drives.

The crawler 26 is a software program or software robot, which is typically used to build lists of the information found on Web sites. Another common term for the crawler 26 is a spider. The crawler 26 typically searches Web sites on the Internet and keeps track of the information located in its search and the location of the information.

The network 16 is a local area network (LAN), wide area network (WAN), a telephone network, such as the Public Switched Telephone Network (PSTN), an intranet, the Internet, or combinations thereof.

The plurality of client systems 18 may be mainframes, minicomputers, personal computers, laptops, personal digital assistants (PDA), cell phones, and the like. The plurality of client systems 18 are capable of being connected to the network 16. Web sites may also be located on the client systems 18. The web search application 28a-f is typically an Internet browser or other software.

The databases 30a-d are stored in storage media located at the server 20, which may include clustered news information, as will be discussed hereinafter. The storage media may be volatile or non-volatile memory that includes, for example, read only memory (ROM), random access memory (RAM), magnetic disk storage media, optical storage media, flash memory devices and zip drives.

In use, the crawler 26 crawls websites, such as the websites of the plurality of client systems 18, to locate information on the web. The crawler 26 employs software robots to build lists of the information. The crawler 26 may include one or more crawlers to search the web. The crawler 26 typically extracts the information and stores it in the database 22. The indexer 24 creates an index of the information stored in the database 22. Alternatively, if a database 22 is not used, the indexer 24 creates an index of the located information and the location of the information on the Internet (typically a URL).

The crawler 26 or a dedicated news information crawler (not shown), may search the web for news information and store the news information and/or properties of the news information in index and/or database, and/or in a dedicated news index and/or news database (not shown). News information may include news articles, blogs, RSS/Atom feeds, video news, or any stream of textual information enriched with other media content. It will be appreciated that different crawlers may be provided for each type of news information. Searchable news information, as will be described hereinafter, may be stored in one or more of databases 30a-d. The news information interface 32 may be connected to the one or more databases 30a-d having news information stored therein, database 22 and/or indexer 24.

When a user of one of the plurality of client systems 18 enters a search on the web search application 28, the search is communicated to the search engine 14 over the network 16. The search engine 14 communicates the search to the server 20 at the search system 12. The server 20 accesses the index and/or database to provide a search result, which is communicated to the user via the search engine 14 and network 16.

If a user of one of the plurality of client systems 18 accesses the news information interface 32 through the web search application 28, the search engine 14 still communicates the search to the server 20, which provides a search result. The search result may be obtained from either or both the web index and the dedicated news information index. The search result is typically searchable news information. As will be described hereinafter, the news information is searchable using a search query, such as a keyword or natural language search, or using a browser.

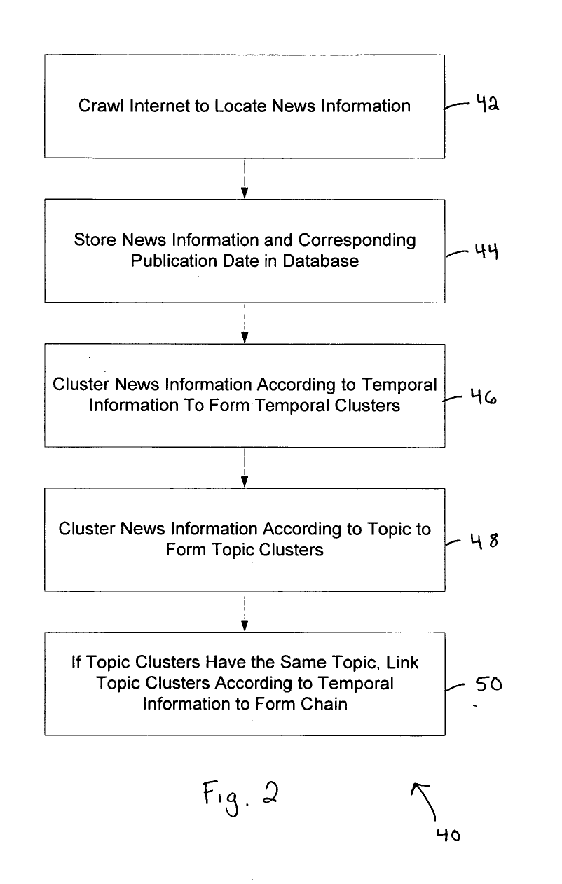

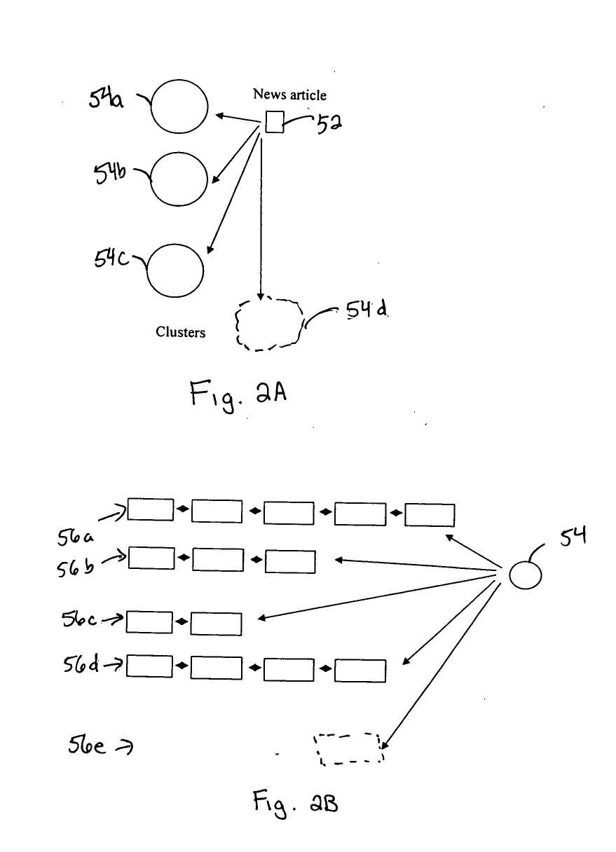

FIG. 2 shows a method 40 for clustering a stream of information in accordance with one embodiment of the invention. At block 42, a crawler, such as crawler 16 (FIG. 1) or a dedicated news information crawler, searches the Internet to locate news information. At block 44, located news information (and/or properties about the news information) is stored in an index and/or database. At block 46, the news information is clustered according to temporal information to form temporal clusters. At block 48, the temporal clusters are clustered according to topic to form topic clusters. At block 50, if topic clusters have the same topic, the topic clusters are linked together to form a chain according to the temporal information.

FIG. 2A shows diagrammatically the process for identifying a topic cluster for a news article. For each news article 52, the system determines whether an existing cluster 54a-c is related to the same topic as the news article 52. If the news article 52 is related to the same topic as one of the existing clusters 54a-c, the news article 52 is added to the corresponding existing cluster. If the news article 52 is not related to the same topic as one of the existing clusters 54a-c, a new cluster 54d is formed for the topic corresponding to the news article 52.

FIG. 2B shows diagrammatically the process for identifying a topic chain for a cluster. For each cluster 54, the system determines whether an existing chain 56a-d is related to the same topic as the cluster 54. If the cluster 54 is related to the same topic as one of the existing chains 56a-d, the cluster 54 is added to the corresponding existing chain. If the chain 54 is not related to the same topic as one of the existing clusters 56a-d, a new chain 56e is formed for the topic corresponding to cluster 54.

In one embodiment, temporal clustering is carried out on daily basis. In this case, the chains of previous days may be consolidated and stored off-line for efficiency reasons. The clusters formed for the current day may be created every m minutes, for example, and dynamically merged with the offline chains.

Each of the clusters and/or chains is typically stored in the external memory. Typically, the external memory includes a database, such as one or more of databases 30a-d, and/or an index, as described hereinabove.

The temporal information used to cluster the information is typically the publication date and/or time, posting date and/or time, clustering date and/or time (i.e., when the news information is clustered) or crawling date and/or time (i.e., when the news information is located, indexed and/or stored by the crawler).

It will be appreciated that although the above process has been described as first clustering the stream of information according to temporal information and, then, topic, the process may also be performed by first clustering the stream of information according to topic and, then, temporal information.

The process for clustering a stream of information typically occurs periodically. The crawler 26 typically locates more news information each time it searches the Internet; thus, the above process may occur concurrently with crawling. Alternatively, a window of time ω, such as an hour, a day, a week, etc. is selected for clustering. It will also be appreciated that news stories in different categories may be clustered at different periods of time and, thus, different periods of time can be selected for different news categories. For example, business news is typically updated more frequently than world news; thus, the time increment for clustering business news may be more frequent (e.g., every five minutes) than the time increment for clustering world news (e.g., every hour).

A clustering algorithm is used to cluster the information according to the selected window of time ω. New clusters can be periodically linked to chains or new topic clusters can be identified periodically. The new clusters are compared to other clusters to discover similarities in topic. When similarities are found among clusters in different time windows, the clusters are linked together to form a chain or are added to a preexisting chain. This comparison with clusters in previous time windows can stop if no similar information is found for a period of time proportional to the extension of the current cluster or to an extension of the chain. The chain of clusters is organized in a hierarchy according to the temporal information of each cluster: the most recent cluster is typically displayed at the top of the chain and the oldest cluster is typically displayed at the bottom of the chain.

In order to determine whether two news stories or two clusters are related to the same topic, the clustering algorithm is used. This algorithm is typically applied to the title of the story. However, each of the news articles or other portions of the news articles may be compared using the algorithm, as well.

The algorithm includes a distance metric D and a set of news stories N1 . . . Nn. The algorithm determines that a cluster includes either a single news story or a cluster C plus a news story Ni such that at least a news story Nj and C exists. The algorithm requires that the distance metric, D(Ni, Nj), be less than d, a threshold, to add a news story Ni to a news story Nj or a cluster C (i.e., determine the news stories are related).

In one embodiment, the distance metric, D(Ni, Nj), is D(Ni, Nj)=1−cw(Ni, Nj)/min(len(Ni), len(Nj)), where cw is the number of words that Ni and Nj have in common, and len is the length in words. It will be appreciated that other distance metrics may also be used.

After it is determined that the stories are related, the titles are extracted from the stories. The stories are then sorted from the last time slot in time descending order. Each title is assigned to a ring, which is initially made up of the news article itself. For each title TJ of a list of related stories, the distances (TJ, TJ-1), (TJ, TJ-2) . . . (TJ, T0) in a cycle are determined. If the title TJ is found to be similar to the title TI, then the rings to which Ti and Tj belong are joined.

The distance D1(C,N) is defined and expresses the distance between a chain C and a cluster N. Each cluster N is added to the tail of a chain C if the chain has a distance D1 smaller than a threshold. The Distance D1 is defined in the following way: given a chain C of N articles C1 . . . CN and a cluster c of n articles c1 . . . cn, the distance D1(C,c) is given by (MIN(D(c1,C1) . . . D(c1,CN))+ . . . +MIN(D(cn,C1) . . . (cn,CN)))/n. In one embodiment, the mean of all the minimal distances of each article ci to some article Cj is lowered by a factor 1/k, where k>=1, and where k is a logarithmic function of the temporal distance of the news articles being compared. A new chain is started with cluster N if the distance D1 is larger than the threshold.

To prevent erroneous cluster or chain aggregation based on similarity between titles/text driven by the presence of words that are meaningless to the news story itself, such as the name of the agency or other common terms, a classic stop-list system may be used to mark words in titles that are not going to be used in the computation of the D distance. The stop-lists containing the words to stop in a title/text may be different for each category and dynamically updated computing the most frequent words of the category dictionary, and adding this sublist to a short static list which could be manually edited during the tuning step of the system.

The above algorithm can reveal paths among stories. For example, the titles “Bird Flu Spreads in Europe,” “H5-N1 Spreads in Europe,” “H5-N1 Diffusion in Europe Grows,” and “H5-N1 Diffusion Further Grows” are all clustered together using the algorithm because they are related, even though their titles do not intersect identically.

Alternatively, similarities among news stories may be identified by searching the articles for keywords. The keywords can then be compared to determine whether a particular news story is related to another news story.

The category of each news information and/or cluster may also be identified. A set of news sources are used to train a classifier for each category C. These sources are a trusted source for the category C. The classifier (e.g., bayesan or SVM) is then used to classify the remaining set of news articles. The classifier may be trained for each defined category C.

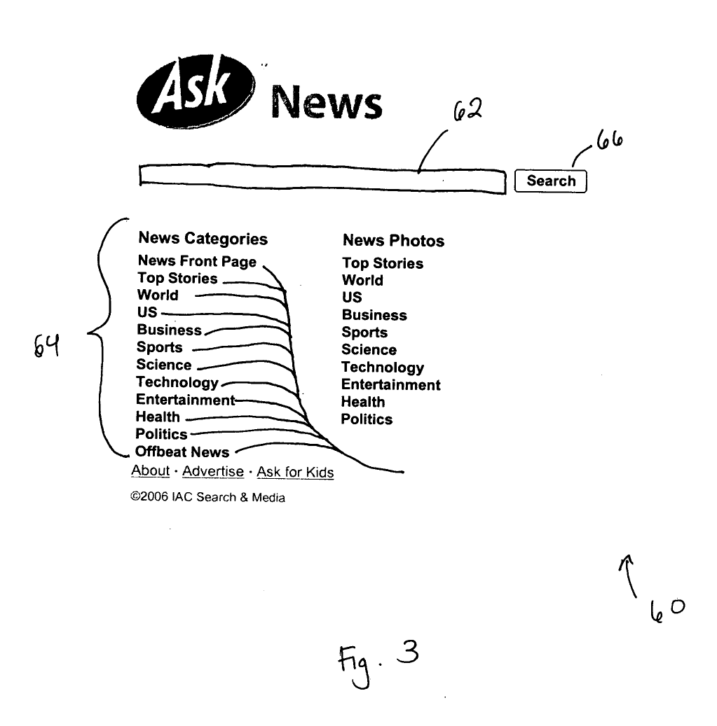

FIG. 3 shows an exemplary user interface 60 for selecting news information in accordance with one embodiment of the present invention. The user interface 60 may be connected to or otherwise related to the news information interface 32 (FIG. 1).

The user interface 60 includes a search box 62 and a list of selectable news categories 64.

The search box 62 may also include a selectable button 66. Users of the user interface 60 enter a search query into the search box 62 and select the selectable button 66 to search for news information related to the search query. The search query may be, for example, a keyword search or a natural language search.

The list of selectable news categories 64 may include selectable links 68 corresponding to each of the categories in the list of selectable news categories 64. Users of the user interface 60 select one of the selectable links 68 from the list of selectable news categories 64 to link to browsable news information relating to the selected news category. It will be appreciated that any number or type of news category may be presented to a user for selection. For example, the illustrated news categories 64 include top stories, world, U.S., business, sports, science, technology, health, politics, entertainment and offbeat news.

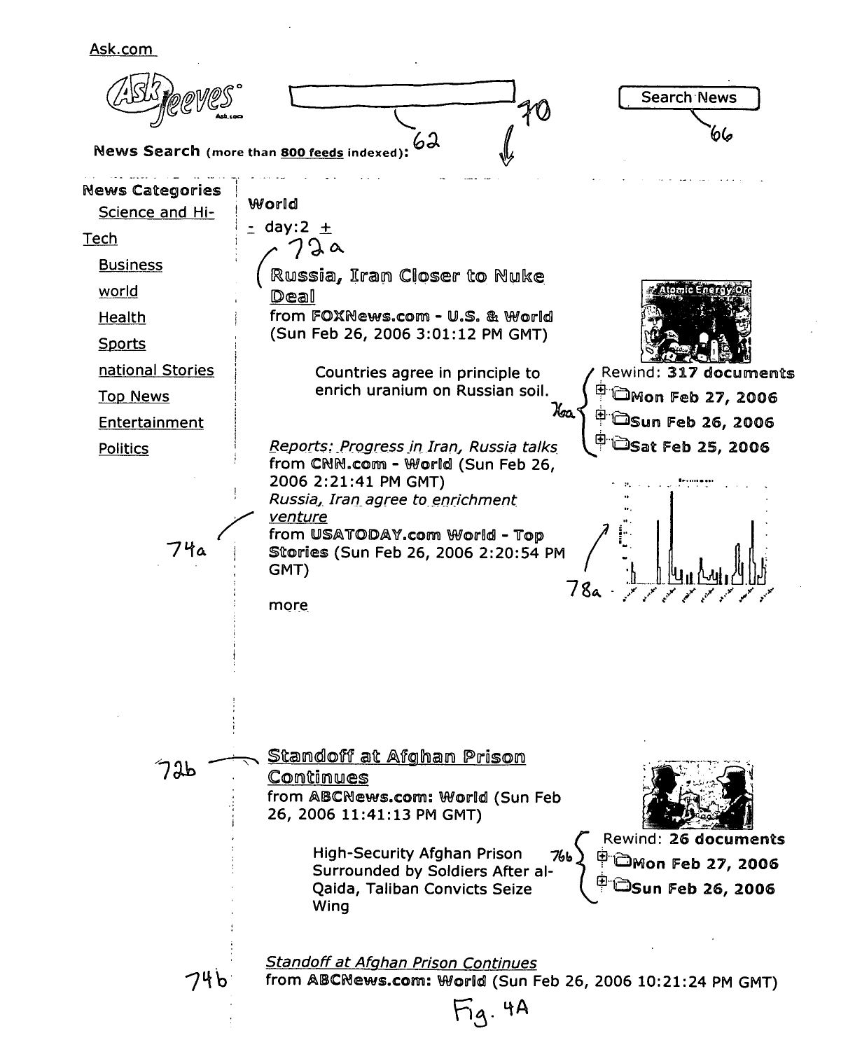

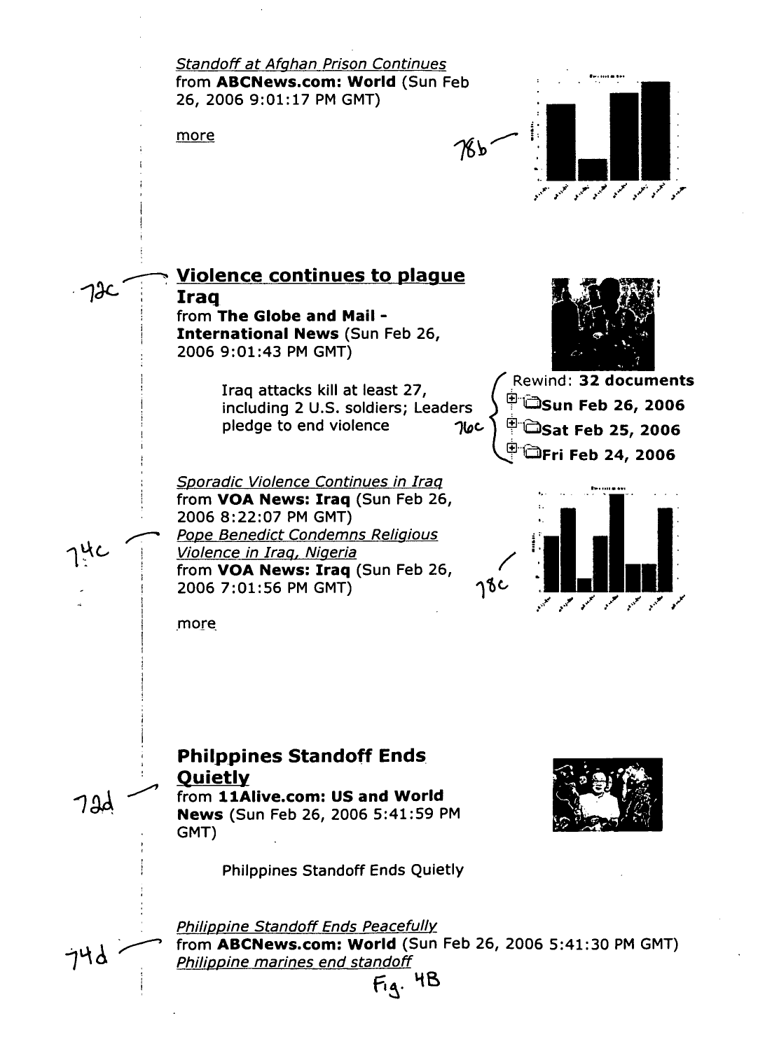

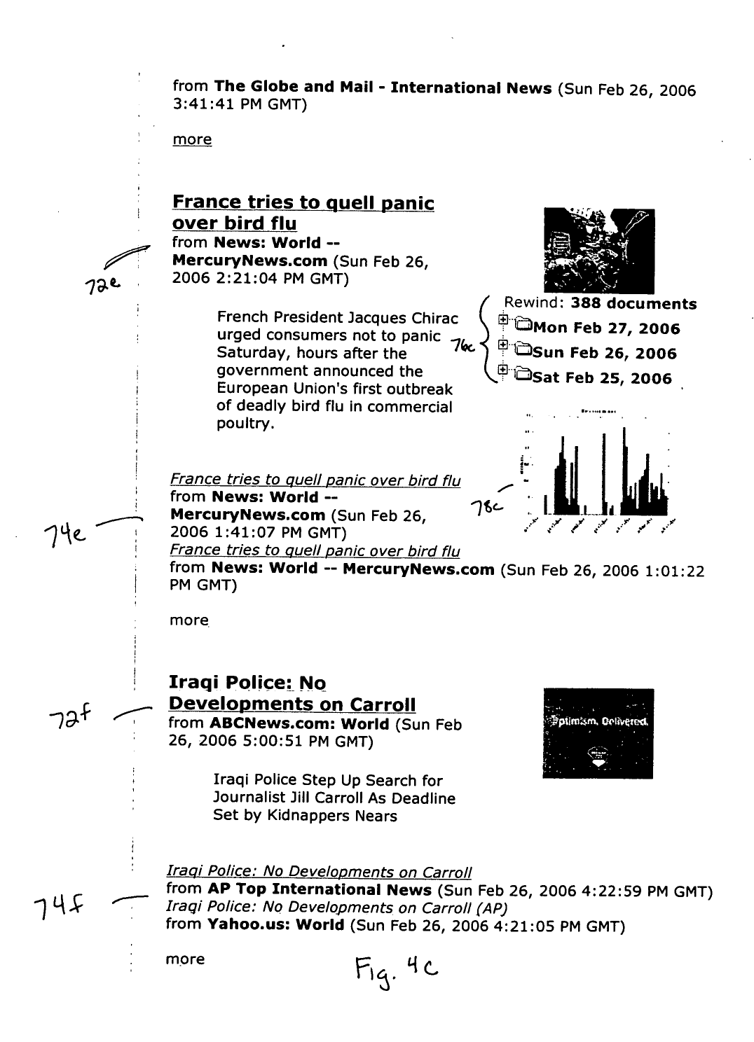

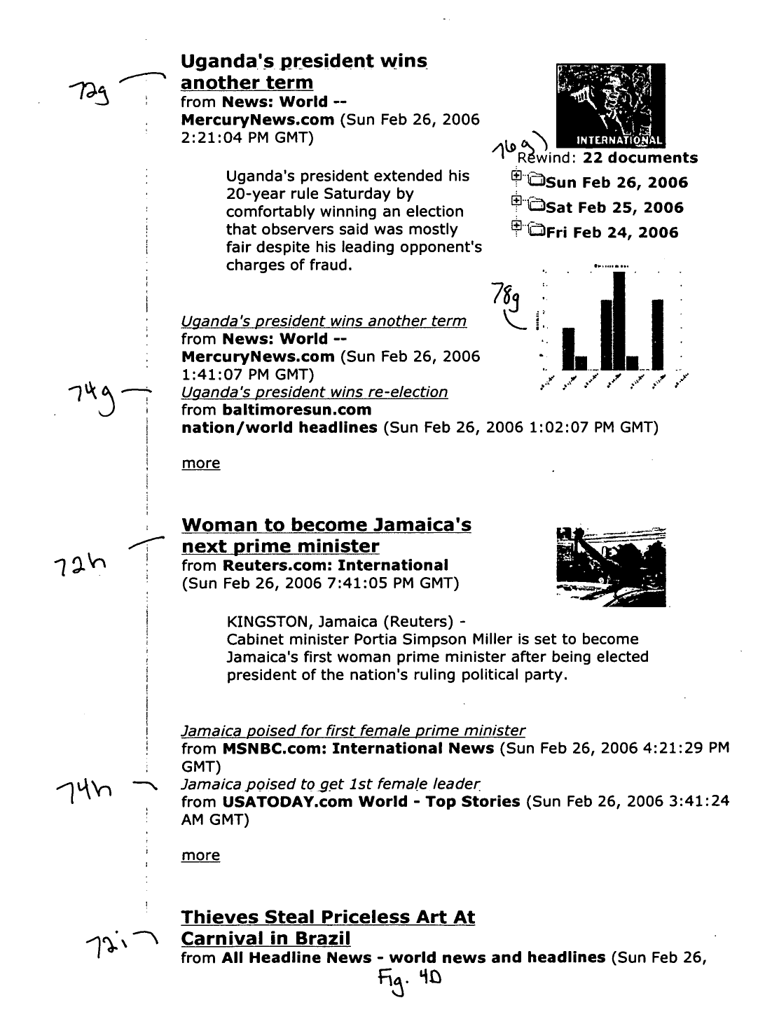

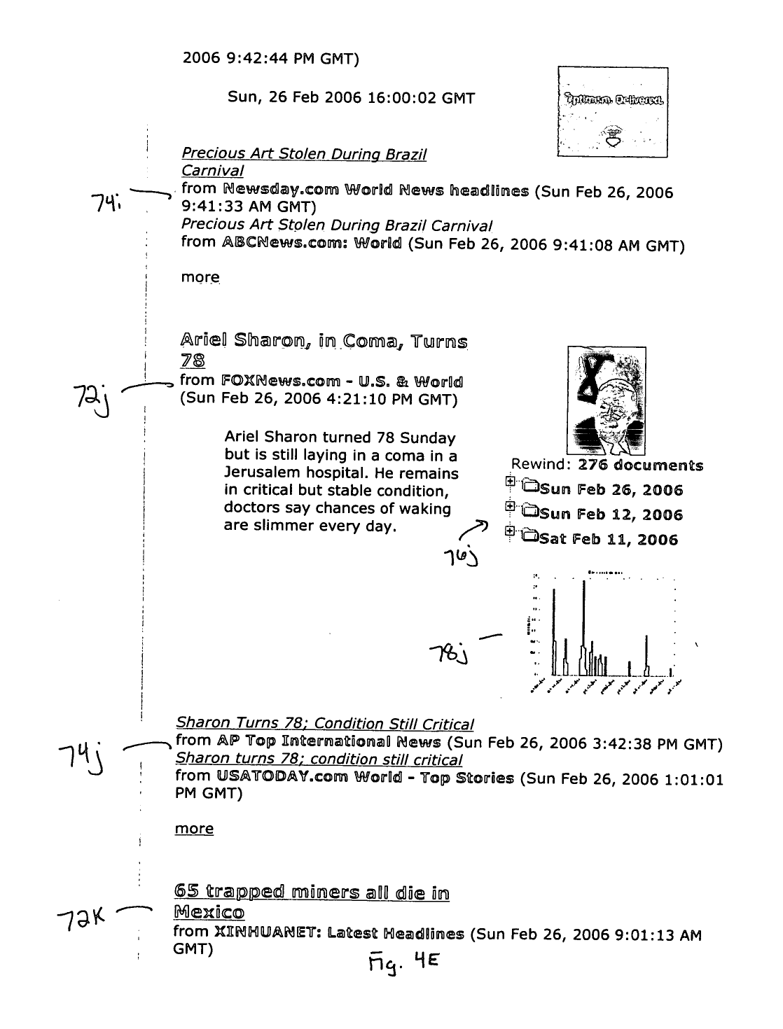

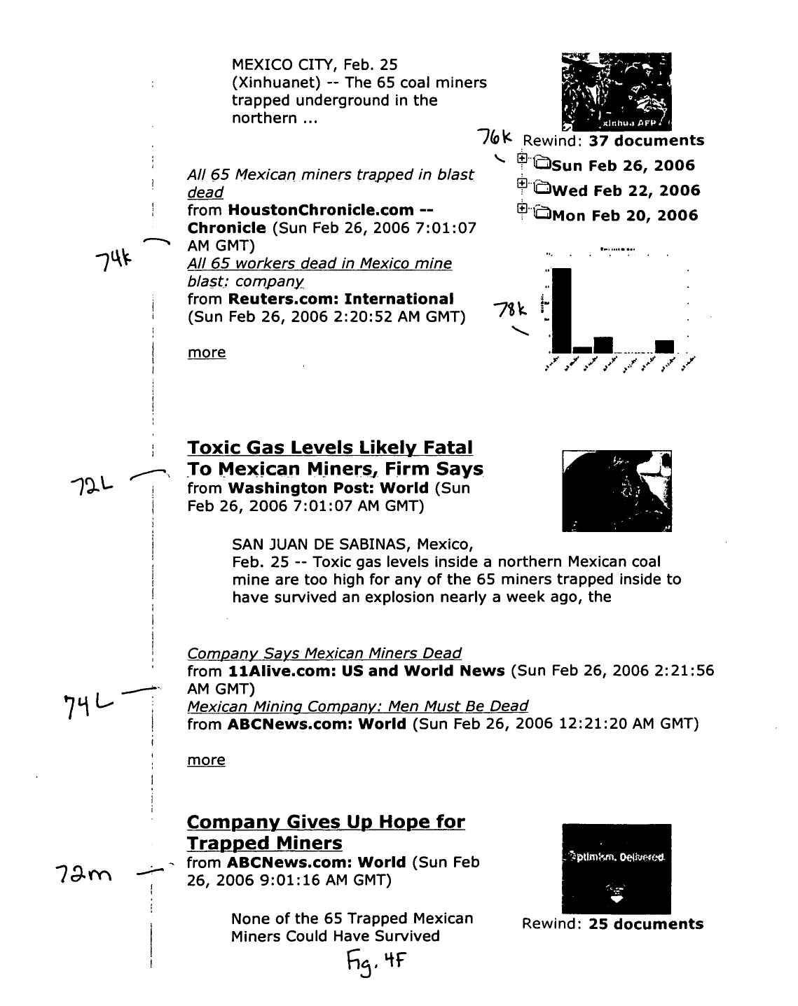

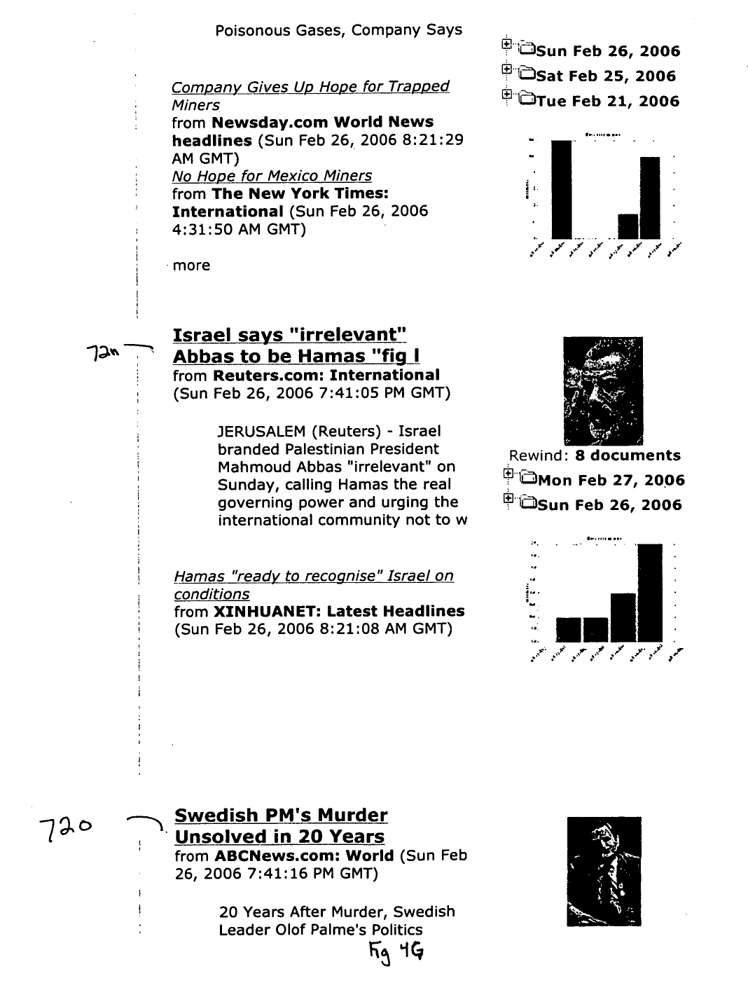

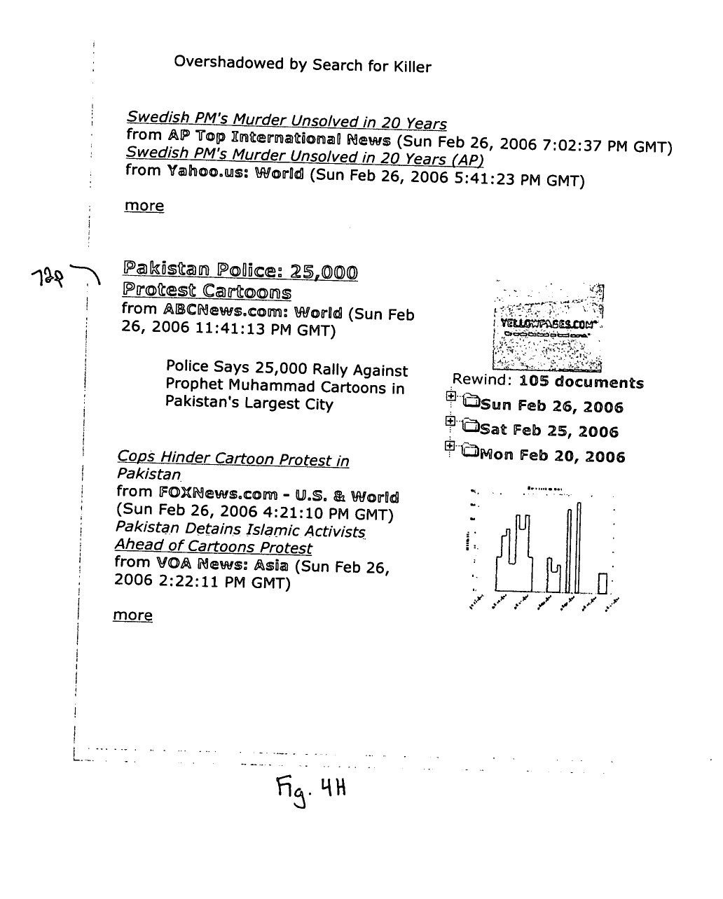

FIGS. 4A-4H illustrate an exemplary user interface 70 for browsing news information related to a selected news category in accordance with one embodiment of the present invention. The illustrated user interface 70 is typically presented to a user in response to a selection of one of the categories 64 in the user interface 60. The illustrated user interface 70 is directed to “world” news information, based on a user selection of the “world” news category link from the list of categories 64 in the user interface 60.

As illustrated in FIG. 4A, the user interface 70 includes a list of representative news stories 72a-72o, related news stories 74a-74o, temporal information 76a-76o and a histogram 78a-78o. The user interface 70 may also include a search box 62 and selectable button 66, as described above with reference to FIG. 3.

The list of representative news stories 72a-72o, related news stories 74a-74o, temporal information 76a-76o and histogram 78a-78o together represent a topic cluster.

It will be appreciated that not all of the representative news stories 72a-72o will have related news stories, temporal information or histograms. For example, new story 72d does not include temporal information or a histogram.

The representative news stories 72a-72o are typically presented with a title corresponding to the news story and may include other information about the news story, such as, for example, the source, news category, publication or posting date and/or time, a brief summary, and a photograph.

Similarly, each of the related news stories 74a-74o may include the title, source, news category, publication or posting date and/or time, a brief summary, and a photograph (or different media types, such as, for example, embedded video). The related news stories 74a-74o are determined to be related to the representative news stories 72a-72o using the algorithm described above or using any other method for determining relatedness among stories.

The temporal information 76a-76o corresponds to temporal clusters for a topic corresponding to each of the news stories 72a-72o. The illustrated temporal information 76a-76o relates to the publication date; however, other temporal information can be used, as described above. One or more temporal clusters together may illustrate a chain or a portion of a chain of temporal clusters corresponding to the topic.

The histograms 78a-78o are a graphical representation of the temporal information for the topic cluster (i.e., a graphical representation of the temporal cluster for a given topic).

Users can select on any of the representative news stories 72a-72o, related news stories 74a-74o, temporal information 76a-76o or histograms 78a-78o to access more information about the new article, topic cluster and/or temporal cluster. For example, if the user selects the representative news stories 72a-72o or the related news stories 74a-74o, the user is typically presented with the news article corresponding to the selected story. If the user selects the temporal information 76a-76o, the user is typically presented with the temporal cluster for the selected topic, as will be described in more detail hereinafter. If the user selects the histogram 78a-78o, the user is typically presented with a larger image of the histogram and, optionally, the temporal cluster for the selected topic, as will be described in more detail hereinafter.

For example, with reference to FIG. 4E, news title 72j is “Ariel Sharon Turns 78.” A summary of related news story 74j is also provided. The title 72j and related news titles 74j correspond to a topic cluster relating to Ariel Sharon. The illustrated temporal information 76j corresponds to the publication date of stories related to Ariel Sharon's coma. A histogram 78j may also be provided with the news article 72j. The histogram 78j includes a graphical representation of the temporal information for the Ariel Sharon topic cluster.

As described above, the user can select on the representative news story 72j, related news stories 74j, temporal information 76j or histograms 78j to access more information about the selected article and/or temporal cluster for the Ariel Sharon story.

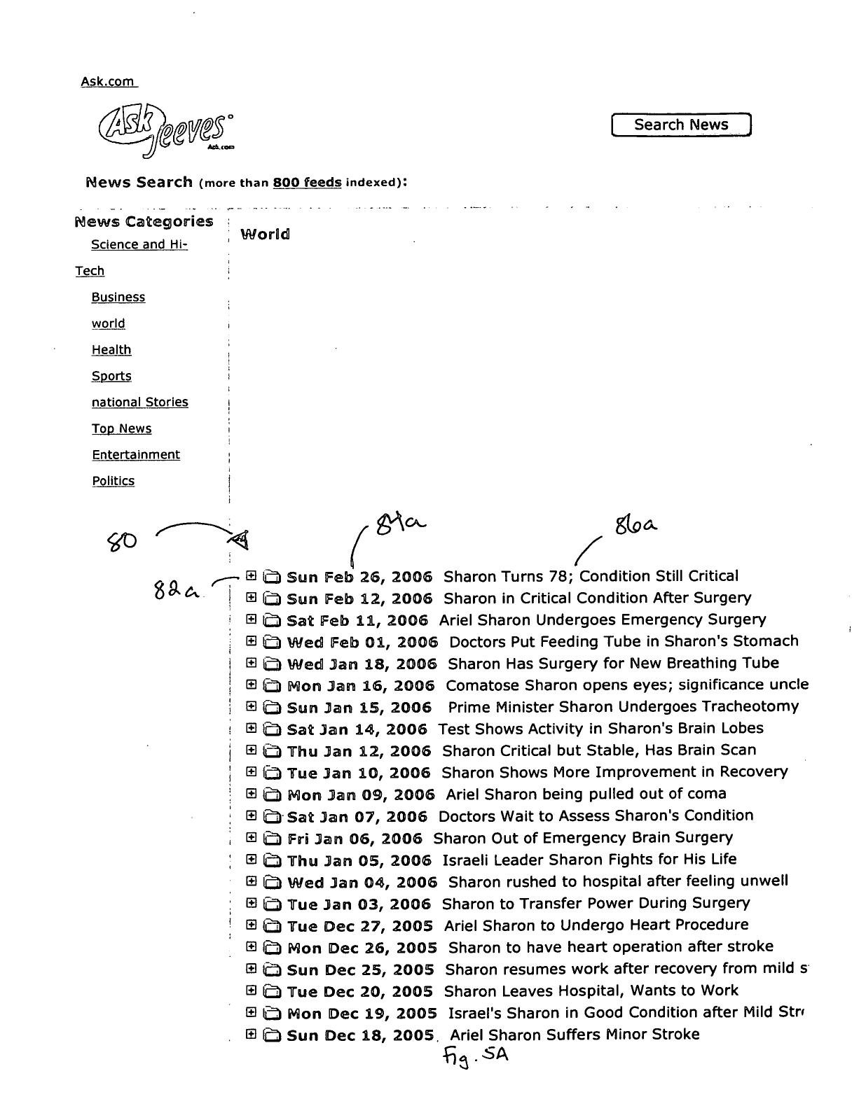

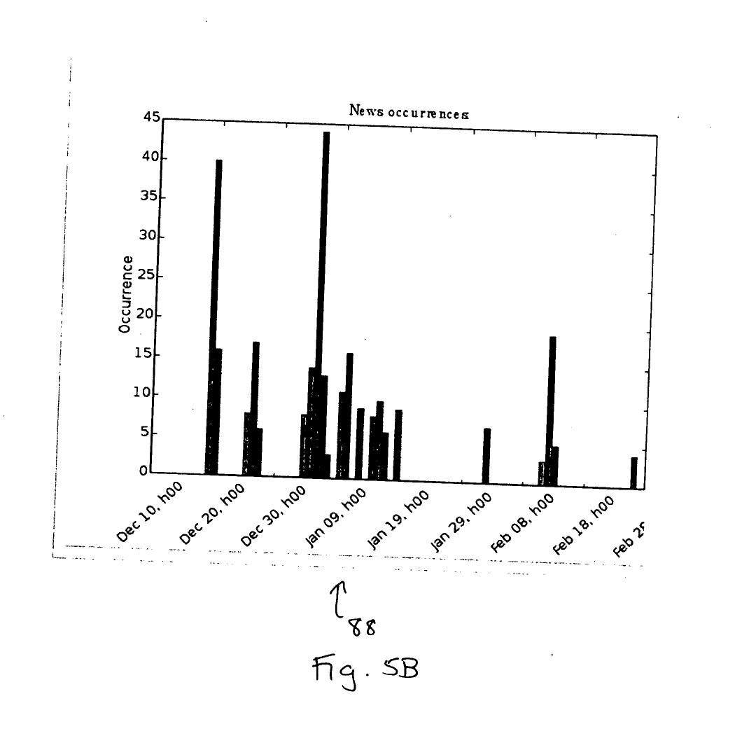

FIGS. 5A and 5B show a user interface 80 for presenting clustered news information in accordance with one embodiment of the invention. The user interface 80 is accessible from a browsable interface, as described above with reference to FIGS. 4A-4H, or from a search query interface, as described above with reference to FIG. 3. In particular, the user interface 80 is typically accessible by selecting the temporal information or histogram from the browsable interface. Alternatively, the user interface 80 may be accessible from a link included in a selected article allowing a user to access additional information about the selected article.

The user interface 80 includes a plurality of clusters 82, a publication date 84 and a representative title 86. The clusters 82 each correspond to a temporal cluster. The clusters 82 together represent a chain of temporal clusters for a particular news story. A user, can therefore, see the temporal evolution of the story from the hierarchy of clusters shown in FIG. 5A.

A user can select the date, title or a defined area or icon near the cluster 82 to access the news article and/or expand the cluster 82.

The illustrated story is related to the topic of Ariel Sharon's coma and the temporal information used to cluster the information is the publication date.

As shown in FIG. 5B, the user interface 80 may also include a histogram 88. It will be appreciated that the histogram 88 can be on a separate user interface, such as, by providing a link from the user interface 80 illustrated in FIG. 5A.

The histogram 88 also shows the hierarchy of temporal clusters related to a selected topic cluster. The hierarchy of clusters illustrates the temporal evolution of a particular news story.

From the illustrated histogram 88, it can be seen that there was a spike in news articles in the topic cluster around December 18 and January 3. Returning to the list of temporal clusters 82 shown in FIG. 5A, it can be seen that the spikes correspond to articles corresponding to Ariel Sharon's stroke and the determination to transfer of power, respectively. Thus, users can use the histogram 88 to evaluate the temporal evolution of the news story graphically.

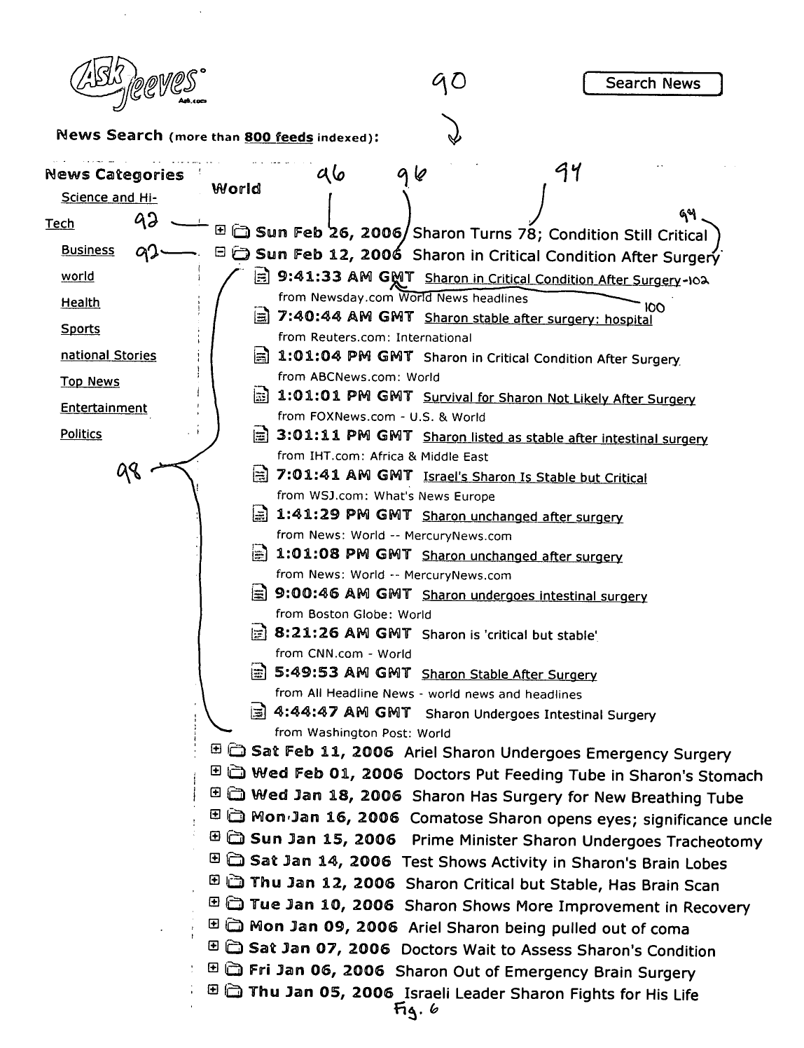

FIG. 6 shows an exemplary user interface 90 having an expanded cluster 92.

Each cluster 92 is identified with temporal information 94 and a representative title 96. The cluster 92 is expandable with a user selection of the cluster 92 or a defined area near the cluster 92.

The expanded cluster 92 includes a plurality of news stories 98. Each of the plurality of news stories 98 includes a publication time 100 and a title 102. A user can select any of news stories 98 to access the full article.

Although user interface 90 has been described with respect to the publication date as the temporal information, it will be appreciated that the temporal information may alternatively be the posting date, clustering date or crawling date, as described hereinabove.

Thus, with user interfaces 80 and 90, the user is able to browse the topic and/or temporal clusters and browse within the chains. A user can follow the temporal evolution along the chain of clusters. That is, a user can “jump” within a chain of clusters, moving forward and/or backward through the chain.

When a user enters a search query, the most relevant articles and/or clusters in a chain are typically provided as the search result. The user can follow the temporal evolution moving back and forth within the chain with user interfaces 80 and 90 using a search query, as well.

An advantage of the systems and methods described herein is that by clustering a stream of information according to the topic and temporal information and linking the related clusters in chains according to the temporal information, a historical evolution of the story can be presented to users. The user can navigate through the chain using rewind and forward links in the articles that allow a user to move through the evolution of the story.

Another advantage of the systems and methods described herein is that information is determined to be related using a clustering algorithm that reveals paths in the evolution of a news story.

In addition, search results can be improved because users are presented with more detailed information.

Another advantage of the systems and methods described herein is ranking. Chains and Clusters are an important tools for ranking because certain articles can be given more importance. For example, articles which are produced by an important news source, are fresh (e.g. produced recently), belong to a dense cluster (e.g. an hot topic), for a fixed day, have a temporal importance which can be inferred by the chain may be ranked higher. In addition, 1) a long chain/high density of recent articles is more important than a short/low density chain of recent articles, 2) a long chain/high density of recent articles is more important than a long chain/low density of old articles, 3) a short chain/low density of recent articles may be more important than a long chain of old articles, etc. Thus, clusters and chains can be used to effect importance ranking.

The foregoing description with attached drawings is only illustrative of possible embodiments of the described method and should only be construed as such. Other persons of ordinary skill in the art will realize that many other specific embodiments are possible that fall within the scope and spirit of the present idea. The scope of the invention is indicated by the following claims rather than by the foregoing description. Any and all modifications which come within the meaning and range of equivalency of the following claims are to be considered within their scope.

1. A method for presenting information comprising:
receiving a request from a user to search news information for a topic;
presenting the user with news information for the topic in accordance with the request, the news information presented in a hierarchy corresponding to temporal information of the news information.

2. The method of claim 1, wherein the temporal information is selected from the group consisting of publication time, clustering time, posting time, crawling time and combinations thereof.

3. The method of claim 1, wherein receiving a request comprises receiving a search query for the topic.

4. The method of claim 1, wherein receiving a request comprises receiving a selection from a browsable list of topics.

5. The method of claim 1, wherein the temporal information comprises an incremental time period and the hierarchy includes a plurality of selectable links corresponding to the incremental time period.

6. The method of claim 5, further comprising receiving a selection of a selectable link corresponding to the incremental time period and presenting the news information corresponding to the incremental time period.

7. The method of claim 1, further comprising presenting a graphical illustration of the temporal information corresponding to the requested topic.

8. A method for organizing related news information comprising:
clustering a stream of news information according to temporal information of the stream of news information to form a plurality of temporal clusters; and
clustering each of the plurality of temporal clusters according to a topic of each news information to form a plurality of topic clusters.

9. The method of claim 8, further comprising linking each of the plurality of topic clusters with topic clusters having the same topic according to the temporal information to form topic chains.

10. The method of claim 8, wherein the stream of news information is clustered periodically to form a plurality of periodic topic clusters.

11. The method of claim 10, further comprising linking each of the plurality of periodic topic clusters with each of the plurality of periodic topic clusters having the same topic according to the temporal information.

12. The method of claim 8, wherein the temporal information is selected from the group consisting of the publication time, crawling time, posting time, clustering time and combinations thereof.

13. A search system comprising:
a crawler to periodically search for news information;
an index, connected to the crawler, to store located information; and
a server, connected to the index, to cluster the news information according to temporal information and a topic of the news information.

14. The system of claim 13, wherein the server is further to cluster the news information periodically.

15. The system of claim 14, wherein the server is further to link clustered news information according to the topic and the temporal information of the news information to form topic chains.

16. The system of claim 15, where the index is further to store the clustered news information.

17. The system of claim 13, further comprising a database to store the clustered news information.

18. The system of claim 13, further comprising an interface for receiving user requests for the clustered news information.

19. The system of claim 18, wherein the interface provides a response to the user request, the response being news information corresponding to the user request.

20. The system of claim 19, wherein the interface allows a user to navigate the response according to the temporal information.

21. The system of claim 13, wherein the temporal information is selected from the group consisting of publication time, crawling time, posting time, clustering time and combinations thereof.

22. The system of claim 13, wherein the server is further to generate a graphical representation of the clustered news information.
